(19) United States
(12) Patent Application Publication
(10) Pub. No.: US 2006/0043339 A1
(43) Pub. Date: Mar. 2, 2006

(54) Phosphor and plasma display panel

(75) Inventor: Kazuya Tsukada, Kanagawa (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/210,479

(22) Filed: Aug. 24, 2005

(30) Foreign Application Priority Data
Aug. 27, 2004 (JP) JP2004-248496

(51) Int. Cl. C09K 11/08

(52) U.S. Cl. 252/301.4 R; 252/301.6 F; 252/301.4 H; 252/301.4 S; 252/301.4 F; 252/301.4 P; 252/301.6 R; 252/301.6 S

(57) ABSTRACT

A phosphor comprising phosphor particles containing a phosphor base material dispersed with an activator and a co-activator, wherein a concentration of the co-activator is lower at a surface than in an interior of each particle.

This application is based on Japanese Patent Application No. 2004-248496 filed on Aug. 27, 2004 in Japanese Patent Office, the entire content of which is hereby incorporated by reference.

### TECHNICAL FIELD

The present invention relates to a phosphor and a plasma display panel manufactured by using the phosphor, and specifically to a phosphor containing an activator and a co-activators, and to a plasma display panel using the phosphor containing the activator and the co-activator.

### BACKGROUND

In recent years, plasma display panels are attracting attention as a flat panel display that is an alternative to cathode ray tubes (CRTs) because they offer large sized screens and thin displays.

A plasma display panel has two glass plates provided with electrodes, and a plurality of minute discharge spaces (referred to hereinafter as cells) formed by partition walls provided between the glass plates. The inner walls of these cells are provided with coatings of phosphors that emit light of the colors red (R), green (G), and blue (B), and the cells are filled with discharge gas whose main component is Xe. By applying a voltage between the electrodes and causing discharge selectively in the cells arranged in an orderly manner on the glass plates, ultraviolet rays are emitted due to the gas discharge in the cell, and the phosphors get excited by the ultraviolet rays and emit visible light of different colors.

Enhancement of luminance and smooth display of moving images is being demanded in such plasma display panels, and conventionally, in order to enhance the luminance, technologies have been known for dispersing in the base material of the phosphor activators that include in them metals that act as light emission color centers.

Further, in order to further increase the luminance, a technology has been disclosed in Patent Document 1 in which a co-activator is dispersed together with an activator in the phosphor base material. In Patent Document 1, for example, calcium or strontium has been added as an co-activator to the phosphor base material made of zinc silicate using manganese as the activator material.

Further, a technology has been disclosed in Patent Document 2 for improving the resistance to degradation due to vacuum ultraviolet rays or ion sputtering by controlling the distribution of activator concentration in the particles of the phosphor where the concentration of an activator in the surface of a particle of the phosphor is smaller than the concentration of the activator in the interior of the particle of the phosphor.

On the other hand, in order to obtain a plasma display panel with still higher performance characteristics, the present inventors studied the problem of developing the technology of preventing the luminance degradation with time. The causes of luminance degradation with time are considered to be: (1) the surface of the particle of the phosphor gets damaged due to vacuum ultraviolet ray irradiation or ion sputtering at the time of plasma generation; (2) the drive is made unstable due to internally adsorbed gases being released with passage of time; and (3) thermal degradation due to gas adsorption or oxidization at the time of baking after coating the phosphor paste during the manufacture of the display panel, and means were needed for removing these problems.

However, in Patent Document 1, although the luminance has been improved, it has not been fully successful to prevent degradation of luminance with time. Further, in Patent Document 2, although improvement has been made in the resistance to degradation caused by vacuum ultraviolet rays or ion sputtering, it has not been fully sufficient for preventing degradation of luminance with time.

In this manner, the means for improvement that can prevent degradation of luminance with time have not been fully sufficient, including those in Patent Document 1 and Patent Document 2, and it is imperative to obtain phosphor that can prevent degradation of luminance with time in order to obtain a high performance plasma display panel.

(Patent Document 1) Japanese Patent Publication Open to Public Inspection (hereafter referred to as JP-A) No. 2002-249767

(Patent Document 2) JP-A No. 2004-91622

### SUMMARY OF THE INVENTION

An object of the present invention is to provide a phosphor that can prevent degradation of luminance with time and a plasma display panel manufactured by using the phosphor.

One of the aspects of the present invention is a phosphor comprising phosphor particles containing a phosphor base material dispersed with an activator and a co-activator, wherein a concentration of the co-activator is lower at a surface than in an interior of each particle.

### BRIEF DESCRIPTION OF THE DRAWINGS

FIG. 1 is an outline configuration diagram of the double-jet reaction apparatus used in the present invention.

FIG. 2 is a perspective view of an example of the plasma display panel according to the present invention.

FIGS. 3(a) and 3(b) are diagrams showing the activator concentration present in the phosphor particles of the inventive samples and the comparative samples of Example 1.

FIGS. 4(a) and 4(b) are diagrams showing the co-activator concentration present in the phosphor particles of the inventive samples and the comparative samples of Example 1.

FIGS. 5(a) and 5(b) are diagrams showing the activator concentration present in the phosphor particles of the inventive samples and the comparative samples of Example 2.

FIGS. 6(a) and 6(b) are diagrams showing the co-activator concentration present in the phosphor particles of the inventive samples and the comparative samples of Example 2.

FIGS. 7(a) and 7(b) are diagrams showing the activator concentration present in the phosphor particles of the inventive samples and the comparative samples of Example 3.

FIGS. 8(a) and 8(b) are diagrams showing the co-activator concentration present in the phosphor particles of the inventive samples and the comparative samples of Example 3.

### DESCRIPTION OF THE PREFERRED EMBODIMENTS

In order to solve the above problems, the invention according to Claim 1 is a phosphor in which an activator and a co-activator are dispersed in a phosphor base material, has the feature that the concentration of the co-activator at the surface of the particle of the phosphor are lower than the concentration of the co-activator in the interior of the particles of the phosphor.

According to the invention disclosed in Claim 1, because the phosphor in which an activator and a co-activator are dispersed in a phosphor base material has the feature that the concentration of the co-activator at the surface of each particle of the phosphor are lower than the concentration of the co-activator in the interior of the particles of the phosphor, the amount of the co-activator is less at the surface of the phosphor particle where the vacuum ultraviolet rays are mostly absorbed and hence it is possible to reduce the crystal defects.

The invention disclosed in Claim 2 is a phosphor according to Claim 1 above with the feature that the concentration of the co-activator gradually increase from the outermost surface of each phosphor particle towards the interior.

According to the invention disclosed in Claim 2, since the concentration of the co-activator gradually increases from the outermost surface of each phosphor particle towards the interior, it is possible to prevent exposure of a crystal portion exhibiting an extreme difference in concentration, which may occur during an ion-sputtering process.

The invention described in Claim 3 is a phosphor according to Claim 1 or Claim 2 above with the feature that the average concentration of the co-activator in a depth range of 0 to 100 nm from the outermost surface of each phosphor particle are less by 20% or more than the concentration of the co-activator anywhere in the interior of each particle deeper than the 100 nm depth position.

According to the invention disclosed in Claim 3, since the concentrations of the activator and co-activator at the outermost surface of each phosphor particle are less by 20% or more than the concentrations of the activator and co-activator in the interior of each particle deeper than the 100 nm depth position, it is possible to further reduce the crystal defects by controlling the concentration of the co-activator particularly in the reason of within 100 nm from the outermost surface.

The invention described in Claim 4 is a phosphor with the feature that an activator and a co-activator are dispersed in a phosphor base material, wherein both the concentrations of the activator and the co-activator at the surface of each particle of the phosphor is lower than the concentrations of the activator and the co-activator in the interior of each particle of the phosphor.

According to the invention disclosed in Claim 4, since both the concentrations of the activator and the co-activator at the surface of each particle is lower than the concentrations of the activator and the co-activator in the interior of each particle of the phosphor, it is possible to further improve the crystalline nature, and to prevent the degradation due to vacuum ultraviolet rays or sputtering as well as the degradation during the baking process in the process of manufacturing plasma display, because in the case of Claim 1, only the concentration of the co-activator is controlled.

The invention described in Claim 5 is a phosphor according to Claim 4 above with the feature that both the concentrations of the activator and the co-activator gradually increase from the outermost surface to the interior of each particle of the phosphor.

According to the invention disclosed in Claim 5, since both the concentrations of the activator and the co-activator gradually increase from the outermost surface to the interior of each particle of the phosphor, it is possible to prevent exposure of a crystal portion exhibiting an extreme difference in concentration, which may occur during an ion-sputtering process, while in the case of Claim 2, only the concentration of the co-activator is controlled and that of the activator is not controlled.

The invention described in Claim 6 is a phosphor according to Claim 4 or Claim 5 with the feature that the concentration of the co-activator at the outermost surface of each phosphor particle are less by 20% or more than the concentration of the co-activator in the interior of each particle deeper than the 100 nm depth position.

According to the invention disclosed in Claim 6, since the average concentrations of the activator and the co-activator within 100 nm from the outermost surface of the phosphor particle is less by 20% or more than the average concentrations of the activator and the co-activator, respectively, in the interior of the particle deeper than the 100 nm depth position, compared to Claim 3 in which only the concentration of the co-activator is controlled, in this case even the concentration of the activator is controlled, and hence it is possible to further reduce the crystal defects.

The invention described in Claim 7 or Claim 8 is a phosphor according to the invention disclosed in any one of Claim 1 to Claim 6 above with the feature that the region up to a depth of 10 nm from the outermost surface of each particle of the phosphor is only the phosphor base material.

According to the invention disclosed in Claim 7 or Claim 8, since the region up to a depth of 10 nm from the outermost surface of each particle of the phosphor is only the phosphor base material, and the activator and the co-activator causing crystal distortion are not present in the range where degradation due to vacuum ultraviolet rays is likely to occur, it is possible to prevent degradation due to vacuum ultraviolet rays.

The invention described in Claim 9 or Claim 10 is a phosphor according to the invention disclosed in any one of Claim 1 to Claim 8 above with the feature that the base material of the phosphor base material is BaMgAl₁₀O₁₇, the activator is Eu, and the co-activator is Be, Mg, an alkaline earth metal, a transitional metal or a rare earth metal.

According to the invention disclosed in Claim 9 or Claim 10, since the base material of the phosphor is BaMgAl₁₀O₁₇, the activator is Eu, and the co-activator is Be, Mg, an alkaline earth metal, a transitional metal or a rare earth metal, a similar effect as in any one of Claim 1 to Claim 7 is obtained, particularly in blue color phosphors manufactured using this phosphor base material as well as activator and co-activator materials.

The invention described in Claim 11 or Claim 12 is a phosphor according to the invention disclosed in Claim 1 to Claim 8 above with the feature that the base material of the phosphor base material is ZnₓSiO₄, the activator is Mn_{y}, and the co-activator is Ml_{z}, where Ml is Be, Mg, an alkaline earth metal, a transitional metal or a rare earth metal, and 1.4≦x<2.0, 0<y≦0.3, 0<z≦0.2.

According to the invention disclosed in Claim 11 or Claim 12, since the base material of the phosphor base material is ZnₓSiO₄, the activator is Mn_{y}, and the co-activator is Ml_{z}, a similar effect is obtained as in any one of Claim 1 to Claim 8, particularly in green color phosphors manufactured by using this phosphor base material as well as activator and co-activator materials.

The invention described in Claim 13 or Claim 14 is a phosphor according to any one of Claim 1 to Claim 8 above with the feature that the phosphor base material is (YₓGd₁₋ₓ)BO₃, the activator is Eu, and the co-activator is Be, Mg, an alkaline earth metal, a transitional metal or a rare earth metal.

According to the invention disclosed in Claim 13 or Claim 14, since the phosphor base material is (YₓGd₁₋ₓ)BO₃, the activator is Eu, and the co-activator is Be, Mg, an alkaline earth metal, a transitional metal or a rare earth metal, a similar effect is obtained as in Claim 1 to Claim 8, particularly in red color phosphors manufactured by using this phosphor base material as well as activator and co-activator materials.

The invention described in Claim 15 or Claim 16 is a plasma display having a discharge cell manufactured by using a phosphor according to any one of the inventions disclosed in Claim 1 to Claim 14.

According to the invention disclosed in Claim 15 or Claim 16, since a phosphor according to any one of the inventions disclosed in Claim 1 to Claim 14 is used in the discharge cell, it is possible to obtain plasma display panels having a phosphor with fewer crystal defects.

According to the invention disclosed in Claim 1, it is possible to improve the crystalline nature because the amounts of the activator and the co-activator are less at the surface of the phosphor particle where the vacuum ultraviolet rays are mostly absorbed and hence it is possible to reduce the crystal defects. Therefore, it is possible to make it stronger against degradation not only due to vacuum ultraviolet rays or sputtering as well as against the degradation during the baking process at the time of manufacturing plasma display. In particular, it is possible to obtain much more enhanced effects such as these because it is possible to further increase the crystalline nature when compared to the case of merely adding an activator or a co-activator in a conventional phosphor without specifically controlling the concentrations, or when compared to the case of controlling only the concentration of the activator added to the base material without specifically controlling the concentration of the co-activator.

As a result, the phosphor according to the present invention makes it possible to prevent such degradations and hence not only the luminance is improved but also it is possible to prevent degradation with time.

According to the invention disclosed in Claim 2, since it is possible to prevent, at the time of etching by ion sputtering, exposure of crystals exhibiting extreme differences in the concentration of component, there is not much difference in the luminous intensities of the etched parts and the non-etched parts, and hence it is possible to reduce the degradation due to ion sputtering.

According to the invention disclosed in Claim 3, since it is possible to further reduce the crystal defects by controlling the concentration of co-activators particularly in this range in the surface of the phosphor particle, it is possible to improve the crystalline nature and, similar to Claim 1, it is possible to make it stronger against degradation not only due to vacuum ultraviolet rays or sputtering as well as against the degradation during the baking process at the time of manufacturing plasma display.

According to the invention disclosed in Claim 4, compared to Claim 1, since it is possible to prevent degradation due to vacuum ultraviolet rays or sputtering as well as the degradation during the baking process at the time of manufacturing plasma display, it is possible not only to enhance the luminance but also to prevent degradation with time.

According to the invention disclosed in Claim 5, compared to Claim 3, since it is possible to prevent, at the time of etching by ion sputtering, exposure of crystals due to extreme differences in the density component, it is possible to reduce the degradation due to ion sputtering.

According to the invention disclosed in Claim 6, compared to Claim 5, since it is possible to further reduce crystal defects, it is possible to make it stronger against degradation not only due to vacuum ultraviolet rays or sputtering as well as against the degradation during the baking process at the time of manufacturing plasma display.

According to the invention disclosed in Claim 7, since activators and co-activators causing crystal distortion are not present in the range in which degradation due to vacuum ultraviolet rays is likely to occur, it is possible to prevent degradation due to vacuum ultraviolet rays and since it is possible to prevent degradation due to vacuum ultraviolet rays, it is possible to increase the luminance as well as to prevent degradation with time.

According to the inventions disclosed in Claim 8 to Claim 10, it is possible to obtain effects similar to Claim 1 to Claim 7 in the phosphors for the colors blue, green, and red manufactured with particularly the compositions of the base material, the activator, and the co-activator, it is possible to prevent degradation due to vacuum ultraviolet rays or sputtering as well as the degradation during the baking process at the time of manufacturing plasma display, and hence it is possible not only to enhance the luminance but also to prevent degradation with time.

According to the invention disclosed in Claim 11, since it is possible to obtain a plasma display panel having a phosphor with fewer crystal defects, similar to Claim 1 it is possible to make it stronger against degradation not only due to vacuum ultraviolet rays or ion sputtering as well as against the degradation during the baking process at the time of manufacturing plasma display.

Some preferred embodiments of the present invention are described here. To start with, the phosphor according to the present invention is described. The present inventors concentrated on ultraviolet ray irradiation, ion sputtering, and baking process during manufacture as the causes of degradation with time in the luminance, and as a result of investigating the internal distributions of co-activators and activators in the particles of the phosphor, were able to greatly improve the problems described above by making the concentration of co-activator or of the activator and co-activator at the surface of the particle smaller than the concentration in the interior of the particle when using a phosphor that has co-activators or activators, and also made it possible to shorten the persistence time.

The effects of the present invention described above are, in concrete terms based on the following structure and operation.

The vacuum ultraviolet ray excited phosphor according to the present invention is one in which activators and co-activators are dispersed in a phosphor base material, the concentration of co-activator on the surface of the particle of the phosphor is lower than the concentration of the co-activator in the interior of the particle of the phosphor, and desirably, the concentrations of the activator and co-activator on the surface of the particle of the phosphor are lower than the concentrations of the activator and co-activator in the interior of the particle of the phosphor.

Further, the concentration of the co-activator is gradually increasing from the surface of the particle of the phosphor towards the interior, and desirably the concentrations of the activator and co-activator are gradually increasing from the surface of the particle of the phosphor towards the interior.

Here, the surface of the particle of the phosphor refers to the range within 100 nm from the outermost surface of the particle of the phosphor, and interior of the particle of the phosphor is the phosphor body of the particle excluding the surface part. It is desirable that each phosphor particle according to the present invention is one in which the average concentration of the activator in a depth range of 0 to 100 nm from the outermost surface of each particle of the phosphor is less by 20% or more than the concentration of the co-activator anywhere in the interior of the particle, and it is still more desirable that the concentration of the co-activator in the depth range of 0 to 100 nm from an outermost surface of each particle of the phosphor is less by 20% or more than the concentration of the co-activator in the interior of the particle, and in particular, it is desirable that the region within 10 nm from the outermost surface of the particle of the phosphor contains only the phosphor base material.

It is desirable to use the following compositions for the phosphor base material, the activator, and the co-activator of the phosphor.

The base material for the phosphor base material for blue color is BaMgAl₁₀O₁₇, the activator is Eu, and the co-activator is Be, Mg, an alkaline earth metal, a transitional metal or a rare earth metal.

The base material for the green phosphor is ZnₓSiO₄, the activator is Mn_{y}, and the co-activator is Ml_{z}, where Ml is an alkali earth metal, a transitional metal or a rare earth metal, and 1.4≦x<2.0, 0<y≦0.3, 0<z≦0.2.

The base material for the red phosphor is (YₓGd₁₋ₓ)BO₃, the activator is Eu, and the co-activator is Be, Mg, an alkaline earth metal, a transitional metal or a rare earth metal.

The method of manufacturing the phosphor according to the present invention is described in the following. The phosphor according to the present invention is obtained by a manufacturing method that includes a precursor forming process that forms the precursor to the phosphor, and a baking process that sinters the precursor obtained in the precursor forming process.

To begin with, the precursor forming process is described below.

In the precursor forming process, after the precursor core particle forming process of forming the core particles of the precursor by dispersing the activator and the co-activator in the phosphor base material according to the method described below, the concentration of the co-activator or the activator and co-activator used during the core particle forming process is gradually reduced and the precursor is formed by forming a shell, having a lower concentration of co-activator or activator and co-activator than in the core particle, on the periphery of the core particles. For example, after the core particle forming process, while maintaining the concentration of the base material, by forming the precursor using the supply of a base material solution with reduced concentration of co-activator or activator and co-activator than the core particle, it is possible to make the concentration of co-activator or activator and co-activator at the surface of the phosphor particle lower than at the interior of the phosphor particle.

At this time, it is possible to form the precursor using the solid phase method, the liquid phase method, or the vapor phase method. However, it is desirable to form the precursor using the liquid phase method in order to enhance the effects of the present invention.

The liquid phase method is the method of obtaining the phosphor by preparing the precursor under the presence of a liquid or within a liquid. In the liquid phase method, since the raw material of the phosphor is made to react within a liquid, it is possible not only to control the concentrations of activators and co-activators with a high precision but also to make uniform the composition of the activator and co-activator with respect to the phosphor base material.

Further, since the liquid phase reaction is carried out between the elemental ions constituting the phosphor, it is possible to obtain a phosphor with a high stoichiometric purity, compared to the solid phase method of manufacturing phosphors by repeatedly carrying out reactions between solid phases and powdering process, it is possible to obtain very fine particles with small particle diameters without having to carry out a powdering process, whereby it is possible to prevent the occurrence of lattice defects in the crystals due to the stresses during powdering and to prevent reduction in the light emission efficiency.

The liquid phase method in the present invention is not particularly limited, and it is possible to use the conventionally known coprecipitation method depending on the type or usage of the phosphor, and it is also possible to use the sol-gel method, or the reaction crystallization method, but it is particularly desirable to use the coprecipitation method and the reaction crystallization method.

The reaction crystallization method is the method, using the crystallization phenomenon, of synthesizing the precursor of the phosphor by mixing solutions that include the element that becomes the raw material for the phosphor. The crystallization phenomenon refers to the phenomenon of a solid phase being precipitated from the liquid phase when there is a change in the state of the mixture system due to changes in the physical or chemical environment due to cooling, evaporation, pH adjustment, concentration, etc., or due to a chemical reaction. The method of manufacturing phosphor precursor by reaction crystallization method in the present invention refers to the manufacturing method due to physical or chemical operation that can induce the occurrence of the crystallization phenomenon such as the above.

Although any solvent can be used at the time of applying the reaction crystallization method as long as the reaction raw materials dissolve in it, it is desirable to use water from the point of view of ease of controlling the degree of super saturation. When several reaction raw materials are to be used, the sequence of adding raw materials can be all of the same time or at different times, and it is possible to determine appropriately the appropriate order depending on the activity of the substances.

Coprecipitation is the method of synthesizing the precursor of the phosphor using the coprecipitation phenomenon by mixing solutions including the elements that become the raw material of the phosphor, by adding further a precipitating agent, and in the state in which the metal elements, etc., that become the activator are precipitated around a nucleus of the phosphor precursor. Coprecipitation is the phenomenon, when precipitation is caused from a solution, of ions that ought not to precipitate accompanying the precipitation although sufficient solubility is present for them in those conditions to remain dissolved. In the manufacture of a phosphor, this is the phenomenon of precipitation of metal elements, etc., that constitute the activator around the nucleus of the phosphor precursor. As has been described above, at the time of obtaining green color phosphor having silicate phosphor, it is desirable to use the coprecipitation method. In that case, it is desirable to use silicon compounds such as silicates as the nucleus of the phosphor precursor, mixing with this solutions containing metal elements such as Zn, Mn, etc., with which it is possible to obtain a green phosphor constitution, and, by further adding a solution having a precipitating agent to this mixture, to cause reaction of solutions containing metals on the surface of the silicon compounds.

For the silica it is possible to use desirably vapor phase silica, wet silica, colloidal silica, etc., and it is desirable that it is effectively not soluble in the solutions given below.

As the solutions applicable at the time of coprecipitation, it is possible to use water, or alcohol types, or their mixtures. When using silicon compounds such as silica etc., it is possible to use methanol, ethanol, isopropanol, propanol, and butanol, in which it is possible to disperse silica compounds. Among these it is desirable to use ethanol in which it is relatively easy to disperse silica compounds.

As the precipitating agents, it is desirable to use organic acids or alkali hydroxides.

As organic acids, it is desirable to use organic acids having a —COOH radical, for example, oxalic acid, formic acid, ascetic acid, tartaric acid, etc., can be used. In particular, it is more desirable to use oxalic acid because when oxalic acid is used it reacts easily with cations of Zn, Mn, etc., and it is easy to precipitate the cations of Zn, Mn, etc., as oxalates. Further, as the precipitating agent it is also possible to use a material that generates oxalic acid due to hydrolysis, for example, dimethyl oxalate, etc. As the alkali hydroxides, it is possible to use a material with a —OH radical, or can be any material that generates an —OH radical after reacting with water or due to hydrolysis, for example, it is possible to use ammonia, sodium hydroxide, potassium hydroxide, urea, etc., and it is desirable to use ammonia which does not include an alkali metal.

When synthesizing precursors by the liquid phase synthesis method including the reaction crystallization method and coprecipitation method, depending on the type of phosphor, it is desirable to adjust the different physical constants such as the reaction temperature, speed of addition or position of addition, stirring conditions, pH, etc. Further, it is also possible to emit ultrasonic waves into the reaction at the time of dispersing the nuclei of the phosphor precursor in the solution. It is also desirable to add protective colloids or surfactants in order to control the average particle diameter. Once the addition of the raw materials has been completed, depending on the need, one of the desirable states is to concentrate and/or mature the liquid.

It is possible to control the particle diameter of the phosphor precursor or its condensation state and to make the average particle diameter of the phosphor after baking reach the desired size by controlling the quantity of protective colloid added or the time duration of ultrasonic ray irradiation, the stirring conditions, etc., and making the status of dispersion satisfactory of the nuclei of the phosphor particles in the solution.

The phosphor precursor obtained in this manner is an intermediate product of the present invention, and it is desirable to obtain the phosphor by baking this phosphor precursor according to a specific temperature described later.

After synthesizing the precursor as has been described above, it is desirable, depending on the need, after recovering using the methods of filtering, evaporation drying, and centrifugal separation, etc., to carry out the processes of cleaning and demineralization.

The demineralization process is a process for removing impurities such as byproduct salts from the precursor of phosphors, and it is possible to use various types of membrane separation methods, coagulation methods, electrodialysis methods, methods using ion exchanging resins, Nudel water washing method, etc.

In the present invention, from the point of view of improving the productivity of manufacturing the phosphor precursor, and also of removing sufficiently the byproduct salts and impurities, and of preventing large sizes of particles or enlargement of particle diameter distributions, it is desirable that the electrical conductivity after demineralization of the precursor is in the range of 0.01 mS/cm to 20 mS/cm, and still more desirably in the range of 0.01 to 10 mS/cm, and particularly more desirably in the range of 0.01 mS/cm to 5 mS/cm.

By adjusting so that the electrical conductivity is as described above, there is also the effect of improving the light emission intensity of the finally obtained phosphor. Further, although it is possible to use any methods for measuring the electrical conductivity, it is sufficient to use a commonly available electrical conductivity measuring instrument.

It is also possible to carry out the drying process after completing the demineralization process.

Next, the baking process is described here.

In the baking process, the phosphor is formed by carrying out the baking process of the phosphor precursor obtained by the precursor forming process.

At the time of baking the phosphor precursor, it is possible to use any method, and it is sufficient to adjust the baking temperature and time so that the performance becomes the highest. For example, it is possible to obtain a phosphor with the intended composition by sinter for a suitable duration at a temperature of 600° C. to 1800° C. in air.

In addition, in case when further large difference is to be created in the concentrations of the co-activator or activator and co-activator at the surface and at the interior of the particles of the phosphor, in order to control the distributions of the concentrations of the co-activator or activator and co-activator, it is also valid to carry out the baking process a plural number of times after changing the conditions. In this case, it is possible to reduce the concentrations of these at the surface of the particles of the phosphor by at least lowering the baking temperature during the final baking process, and by shortening the baking time. In addition, this method is particularly effective when the phosphor precursor is formed by the solid phase method.

Further, it is possible to use all types of baking apparatuses (baking containers) known at present. For example, box type furnaces, skull crucible furnaces, cylindrical furnaces, boat type furnaces, or rotary kilns, etc., are used desirably. Even the atmosphere of baking can be oxidizing, reducing, or inert gases, etc. to suit the composition of the precursor, and can be selected appropriately. In addition, depending on the need, it is also possible to carry out an oxidizing or reducing process after baking.

In addition, it is also possible to add a sintering prevention agent at the time of sintering depending on the need. When adding a sintering prevention agent, it is possible to add it in the form of a slurry at the time of forming the phosphor precursor. In addition, it is also possible to sinter after mixing a powder shaped material with the dried precursor.

There is no restriction on the sintering prevention agent, and is selected appropriately depending on the type of phosphor and the baking conditions. For example, depending on the baking temperature of the phosphor, a metal oxide such as TiO₂ is used desirably for baking at 800° C. or less, SiO₂ is used for baking at 1000° C. or less, and Al₂O₃ is used desirably for baking at 1700° C. or less.

Further, depending on the composition of the phosphor and the reaction conditions, for example, when crystallization has progressed during the drying process, etc. and there may be no need to carry out baking. In such cases, it is also possible to omit the baking process.

After forming the phosphor by carrying out the baking process in this manner, it is also possible to carry out various processes such as a cooling process, a dispersion process, etc., and it is also possible to carry out grading.

In the cooling process, the baked material obtained by the baking process is subjected to a cooling process. Although there is no particular restriction on the cooling process, it is possible to select among the widely known cooling methods, for example, it is also possible to cool the baked material in the condition in which it is still in the baking apparatus. Further, it is also possible to reduce its temperature by merely leaving it to cool down, or else the temperature may be reduced forcibly using a cooling unit while controlling the temperature.

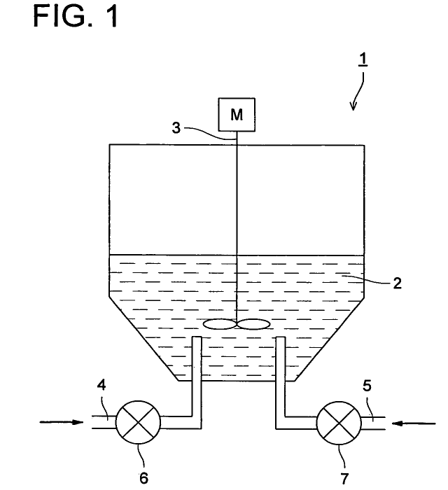

In the dispersion process, the processing is carried out of dispersing the baked material obtained in the baking process. The method of dispersion process can be, for example, the double jet type reaction apparatus 1 as shown in FIG. 1, or an impeller type dispersion unit of the high speed stirrer type, or equipment such as a colloid mill, a roller mill, a ball mill, a vibrating ball mill, an attrition mill, a planetary ball mill, or a sand mill, etc., that move the medium within the equipment and powder the particles by either their collision or their shearing strength or both, or a dry type of dispersing equipment such as a cutter mill, a hammer mill, or a jet mill, etc., an ultrasonic dispersing equipment, or a high pressure homogenizer, etc. Further, the double jet type reaction apparatus shown in FIG. 1 is one in which the dispersing can be done by adding two or more types of liquids simultaneously at the same rate, and is provided with a reaction container 2 for mixing the liquids, and the stirring blades 3 that stir the liquid inside the reaction container 2, and the bottom part of this reaction container 2 is provided with two pipes 4 and 5 that can communicate with the interior of the reaction container 2. Each of the pipes 4 and 5 are provided with nozzles 6 and 7, and also other ends of the pipes 4 and 5 are connected to tanks not shown in the figure, and a pump, not shown in the figure, is connected to each of these tanks and make it possible to inject liquids to the interior of the reaction container 2 simultaneously and at the same speed.

Thereafter, the phosphor paste adjusted as described above is coated inside or poured into the discharge cell 31. Further, at the time of coating or filling the discharge cell 31 with the phosphor, it is possible to carry out these using various methods such as the screen printing method, photoresist film method, ink jet printing method, etc. In particular, even when the pitch of the partition walls 30 is narrow and the discharge cells 31 are formed with very small dimensions, the ink jet printing method is desirable because it makes it possible to coat or pour the phosphor paste uniformly, easily, with high accuracy, and at a low cost between the partition walls.

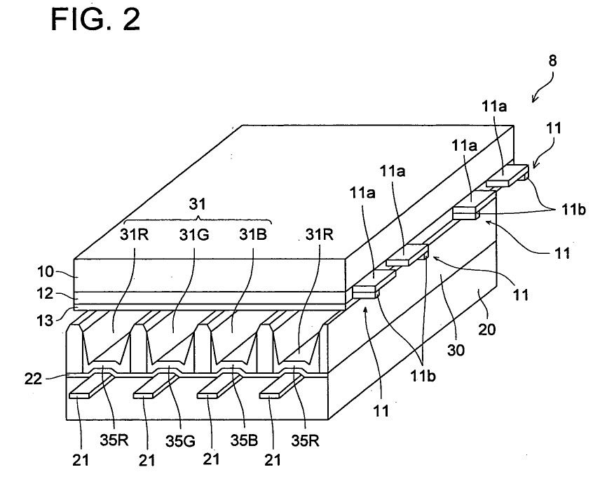

Next, referring to FIG. 2, a preferred embodiment of a plasma display panel according to the present invention is described here. Further, the plasma display panels can be broadly categorized in terms of the electrode structure and operation mode into the DC type in which a DC voltage is applied and the AC type in which an AC voltage is applied, and an example of the outline structure of an AC type plasma display panel is shown in FIG. 2.

The plasma display panel 8 shown in FIG. 2 is provided with a front panel plate 10 that is the substrate positioned on the displaying side, and a back panel plate 20 opposing the front panel plate 10.

Firstly, an explanation will be given here regarding the front panel plate 10. The front panel plate 10 is transparent to visible light, is one that carries out various types of information display on the surface of the substrate, and functions as the displaying screen of the plasma display panel, and display electrodes 11, a dielectric layer 12, and a protective layer 13, etc., are provided on this front panel plate 10.

For the front panel plate 10, it is possible to use, desirably, a material that is transparent to visible light such as soda lime glass (blue plate glass), etc. It is desirable that the thickness of the front panel plate 10 is in the range of 1 to 8 mm, and more desirably is 2 mm.

A plurality of display electrodes 11 are provided on the surface of the front panel plate 10 that is opposing the back panel plate 20, and are arranged in an orderly manner. The display electrodes 11 comprise transparent electrodes 11a and a bus electrode 11b, and their structure is such that on a transparent electrode 11a formed in the shape of a wide stripe is formed a superimposing bus electrode 11b also of with a striped shape. Further, the bus electrode 11b is formed so that its width is smaller than that of the transparent electrode 11a. In addition, the display electrode 11 is formed so that two display electrodes 11 placed opposing each other with a specific discharge gap constitute one set.

It is possible to use a transparent electrode such as a Nesa coated film for the transparent electrode 11a, and it is desirable that its sheet resistance is 100 Ω/sq or less. The width of the transparent electrode 11a should desirably be in the range of 10 to 200 μm.

The bus electrode 11b is for reducing the resistance and can be formed by sputtering, etc., of Cr/Cu/Cr. It is desirable that the width of the bus electrode 11b is in the range of 5 to 50 μm.

The dielectric layer 12 covers the entire surface of the front panel plate, 10 where the display electrodes 11 are placed. The dielectric layer 12 can be formed using a dielectric material such as a low melting point glass, etc. It is desirable that the thickness of the dielectric layer 12 is in the range of 20 to 30 μm. The surface of the dielectric layer 12 is completely covered by the protective layer 13. It is possible to use a MgO layer as the protective layer. It is desirable that the thickness of the protective layer 13 is in the range of 0.5 to 50 μm.

Next, the back panel plate 20 is described.

The back panel plate 20 is provided with an addressing electrode 21, a dielectric layer 22, partition walls 30, and the phosphor layers 35R, 35G, and 35B.

Similar to the front panel plate 10, it is possible to use soda lime glass, etc., for the back panel plate 20. It is desirable that the thickness of the back panel plate 20 is in the range of 1 to 8 mm, and more desirably is about 2 mm.

A plurality of the addressing electrodes 21 are provided on the surface of the back panel plate 20 that is opposing the front panel plate 10. Similar to the transparent electrodes 11a and the bus electrode 11b, even the addressing electrodes 21 are formed in the shape of a stripe. The address electrodes 21 are provided so that they are at right angles to the display electrodes 11 as viewed from the top, and a plural number of these are provided at specific intervals.

It is possible to use metal electrodes such as Ag thick film electrodes as the address electrodes 21. It is desirable that the thickness of the addressing electrodes 21 is in the range of 100 to 200 μm.

The dielectric layer 22 covers the entire surface of the back panel plate 20 where the addressing electrodes 21 *are placed. The dielectric layer 22 can be formed using a dielectric material such as a low melting point glass, etc. It is desirable that the thickness of the dielectric layer 22 is in the range of 20 to 30 μm.

The partition walls 30 formed with rectangular shapes rise up from the back panel plate 20 towards the front panel plate 10 on both sides of the addressing electrodes 21 above the dielectric layer 22, and the partition walls 30 are at right angles to the display electrodes 11 as seen from the top. Further, the partition walls 30 form a plurality of minute discharge spaces 31 (hereinafter referred to as discharge cells) that divide the space between the back panel plate 20 and the front panel plate 10 in the shape of stripes, and a discharge gas comprising mainly an inert gas is filled inside each discharge cell 31.

Further, the partition walls 30 can be formed from a dielectric material such as a low melting point glass, etc. It is desirable that the width of the partition walls 30 is in the range 10 to 500 μm and a width of about 100 μm is still more desirable. Normally, the height of the partition walls 30 is in the range of 10 to 100 μm and a height of 50 μm is desirable.

Any one of the phosphor layers 35R, 35G, and 35B comprising a phosphor according to the present invention and emitting light of any of the colors red (R), green (G), and blue (B) is provided in the discharge cells 31 in a fixed order. Within one discharge cell 31, there are several points where the display electrodes 11 and the addressing electrodes 21 intersect each other as viewed from the top, and with each of these intersection points being the smallest unit of light emission, three successive units of light emission R, G, and B in the left to right direction constitute one pixel. Although, the thickness of each of the phosphor layer 35R, 35G, and 35B is not particularly restricted, it is desirable that it is in the range of 5 to 50 μm.

Further, regarding the formation of the phosphor layers 35R, 35G, and 35B, the phosphor pastes prepared by dispersing the phosphors according to the present invention manufactured using the methods described above with the mixing materials of a binder, a solvent, and a dispersing agent and having their viscosities adjusted to appropriate levels are coated or poured inside the discharge cells 31. Subsequently, by drying and baking the coated or poured phosphor pastes, the phosphor layers 35R, 35G, and 35B are formed in which the phosphors according to the present invention are adhered to the partition wall side surfaces 30a and bottom surfaces 30b. Further, it is possible to carry out the adjustment of the phosphor pastes using any conventionally known method. Also, it is desirable that the content of the phosphor within the phosphor paste is in the range of 30% to 60% by weight.

At the time of coating or pouring the phosphor pastes in the discharge cells 31R, 31G, and 31B, it is possible to use various types of methods such as the screen printing method, the photoresist film method, or the ink jet method, etc.

By constructing a plasma display panel in this manner, at the time of displaying, it is possible to select the discharge cell to be displayed by causing a trigger discharge selectively between the addressing electrode 21 and any one among the pair of display electrodes 11 and 11. Thereafter, by carrying out sustained discharge using the pair of display electrodes 11 and 11 within the selected discharge cell, ultraviolet rays are generated due to the discharge gas, thereby making it possible to generate visible light from the phosphor layers 35R, 35G, and 35B.

Because of the above, in the present invention, after first forming the core particles at the time of forming the phosphor precursor, by decreasing the concentrations of co-activators or of activators and co-activators at the time of forming the core particles and forming the precursor by forming a shell having a lower concentration of co-activators or of activators and co-activators than in the core particles around the periphery of the core particles, it is possible to make smaller the concentration of co-activators or of activators and co-activators at the surface of the phosphor particles than the concentration of co-activators or of activators and co-activators in the interior of the phosphor particles.

Because of this, when compared to the case of merely adding activators or co-activators in a conventional phosphor without specifically stipulating the concentrations, or when compared to the case of stipulating only the concentration of the activator added to the base material without specifically stipulating the concentration of the co-activators, it is possible to further reduce the co-activators or the activators and co-activators at the surface of the phosphor particle where the vacuum ultraviolet rays are absorbed most, and it is possible to decrease the distortions in the crystal structure in the neighborhood of activators and co-activators that occur when the base material is doped with activators and co-activators. In other words, in the phosphor according to the present invention, it is possible to improve the crystalline nature because crystal defects have been reduced. As a result, in the phosphor according to the present invention, it is considered possible to make it stronger against not only vacuum ultraviolet rays but also against ion sputtering and shocks during the baking process at the time of forming the plasma display panel.

As a result, the phosphor according to the present invention makes it possible to prevent such degradations and hence not only the luminance is improved but also it is possible to prevent degradation with time.

Further, these effects are more pronounced when the concentrations of co-activators or of activators and co-activators within 100 nm from the outermost surface of the phosphor particle is less by 20% or more than the concentrations of the co-activators or of activators and co-activators in the interior of the particle deeper than the 100 nm depth position. In particular, in the case when the region up to a depth of 10 nm from the outermost surface of the particle of the phosphor is only the phosphor base material, since activators and co-activators that cause crystal distortion are not present in the range in which degradation due to vacuum ultraviolet rays is likely to occur, it is possible to prevent degradation due to vacuum ultraviolet rays and to enhance further the effects described above.

Further, since the concentrations of the co-activators or of activators and co-activators is increasing gradually from the outermost surface of the phosphor towards its interior, it is possible to prevent, at the time of etching by ion sputtering, exposure of crystals due to extreme differences in the density component. As a result, there is not much difference in the luminous intensities of the etched parts and the non-etched parts, and hence it is possible to reduce the degradation due to ion sputtering.

In addition, by using in a plasma display the phosphor manufactured using the method of manufacture of phosphor according to the present invention, since it is possible to suppress the distortions in the crystals of the phosphor particles and to improve the crystalline nature, it is possible to obtain a plasma display panel 8 in which it is possible to prevent degradations in the luminance with time described above.

Further, we investigated the following items in order to evaluate the effects described above.

In order to evaluate the effect of irradiation with vacuum ultraviolet rays, we irradiated the phosphor layer for 200 hours with vacuum ultraviolet rays of 146 nm wavelength (excimer lamp, manufactured by Ushio Electric), measured the luminance of the phosphors before and after irradiating them with vacuum ultraviolet rays, and evaluated the degree to which the luminance decreased due to irradiation with vacuum ultraviolet rays for long durations (rate of luminance retention).

Further, in order to evaluate the degradation due to ion sputtering, we put the phosphor into a cell assuming a plasma display panel, subjected it to irradiation with Ar ions for three minutes by putting it in an Ar ion sputtering equipment (manufactured by Sanyu Electric), measured the luminance of the phosphors before and after irradiating them with Ar ions, and evaluated the degree to which the luminance decreased due to ion sputtering (rate of luminance retention).

Further, in order to measure the degradation during baking, we measured the luminance before and after baking when the phosphor manufactured using the method described later was baked, and evaluated the degree to which the luminance decreased due to baking (rate of luminance retention).

Further, in order to measure the internal distributions of the co-activators and the activators inside the phosphor particles, we evaluated the concentration distribution of activators and co-activators in terms of the atomic ratios (At %) by carrying out analysis of the activator (Mn) and the co-activator (Mg) up to a specific depth from the outermost surface of the phosphor particle using an X-ray electron spectrophotometer (XPS, manufactured by Nitto Denko) while successively etching the phosphor.

In addition, in order to measure the persistence time, we carried out the measurement of the persistence time of the phosphor using a phosphor life measurement equipment (manufactured by Photon Technology International).

### EXAMPLES

The present invention will now be explained using the following Examples 1 to 3, however, the present invention is not limited thereto.

### Example 1

In Example 1, the phosphor No. 1 according to the present invention using Zn₂SiO₄:Mn:Mg as the green phosphor (where, Zn₂SiO₄ is the phosphor base material, Mn is the activator, and Mg is the co-activator), the phosphor No. 2, and the phosphor No. 3 as the comparison example were prepared, the concentration distributions of the activator and co-activator in the obtained phosphor were measured, and also the paste baking degradation test, vacuum ultraviolet ray degradation test, and the ion sputtering degradation test were carried out and the relative luminous intensities before and after degradation in each process were evaluated. Further, the persistence times of the phosphors were carried out thereby carrying out the persistence evaluation. To begin with, the synthesis of the phosphors No. 1 to No. 3 is explained below.

1. Preparation of Phosphors

(1) Preparation of Phosphor No. 1 by Liquid Phase Method

Water of 1000 ml was taken as liquid A. Na₃SiO₃ was dissolved in 500 ml of water so that the ion concentration of Si becomes 0.50 mol/l, and this was taken as liquid B. ZnCl₂ and MnCl₂.4H₂O, and MgCl₂ were dissolved in 500 ml of water so that the ion concentration of Zn becomes 0.95 mol/l, the ion concentration of the activator (Mn) becomes 0.06 mol/l, the ion concentration of the co-activator (Mg) becomes 0.02 mol/l, and this was taken as liquid C.

Further, solution A was put in the reaction container 2 of the double jet type reaction apparatus 1 which is the equipment for manufacturing the phosphor as shown in FIG. 1, maintained at 40° C. and was stirred using the stirring blades 3. In this condition, the solutions B and C maintained at 40° C. were added at a constant speed of 100 ml/min using pumps via the nozzles 6 and 7 at the bottom part of the reaction container 1. After adding the liquids, the mixture was aged for 10 minutes, thereby obtaining the precursor of the phosphor.

Thereafter, the precursor was cleaned using an ultra-purification equipment (ultra-purification film NTU-3150 manufactured by Nitto Denko) until the electrical conductivity becomes 30 mS/cm. The precursor after cleaning was added to 1000 ml of water and this was again put in the reaction container 1 of FIG. 1, and the dispersed liquid was obtained by stirring this using the stirring blades 3 while maintaining at 40° C. until it was dispersed uniformly.

In this state, the solution B′ maintained at 40° C. and having Na₃SiO₃ dissolved in it so that the ion concentration of Si in 500 ml of water becomes the concentration listed in the following Table 1, and the solution C′ maintained at 40° C. and having ZnCl₂, MnCl₂.4H₂O, and MgCl₂ dissolved in it so that the ion concentrations of the ions Zn, activator (Mn), and of the co-activator (Mg) in 500 ml of water become the densities listed in the following Table 1 are added using pumps at a constant rate of 50 ml/min from the nozzles 6 and 7 present at the bottom part of the reaction container 1 in which the dispersed liquid has been poured. The mixture was aged for 10 minutes after addition, and thereafter the dry precursor was obtained by filtering and drying. This was baked at 1250° C. for 3 hours in a weakly reducing atmosphere (N₂) thereby obtaining the phosphors No. 1-1 to 1-6.

TABLE 1

| Phos- | Si ion | Zn ion | Mn ion | Mg ion |
|---|---|---|---|---|
| phor | concentration | concentration | concentration | concentration |
| No. | (mol/l) | (mol/l) | (mol/l) | (mol/l) |
| 1-1 | 0.45 | 0.9 | 0.027 | 0.009 |
| 1-2 | 0.45 | 0.9 | 0.0135 | 0.0045 |
| 1-3 | 0.45 | 0.9 | 0 | 0 |
| 1-4 | 0.45 | 0.9 | 0.0405 | 0.0135 |
| 1-5 | 0.45 | 0.9 | 0.054 | 0.0045 |
| 1-6 | 0.45 | 0.9 | 0.054 | 0 |

(2) Preparation of Phosphor No. 2 by Solid Phase Method

ZnO and SiO₂ were mixed with a mol ratio of 2:1 as the base material. Next, specific quantities of Mn₂O₃ and MgO₂ were added to SiO₂ in this mixture. At this time, if the quantity of SiO₂ is taken as 1 the addition was made so that the weight percentages of Mn₂O₃ and MgO₂ become 0.15 and 0.05, respectively, and after this mixture was mixed using a ball mill, it was baked at 1250° C. for 2 hours in a weakly reducing atmosphere (N₂).

After further mixing the base materials ZnO and SiO₂ to the synthesized phosphor, Mn₂O₃ and MgO₂ were added so that their weight ratios become as listed in Table 2 below, mixed in a ball mill, baked again at 1150° C. for 1.5 hours in air thereby obtaining the phosphors No. 2-1 to No. 2-6.

TABLE 2

| Phosphor No. | Mn/Si ratio | Mg/Si ratio |
|---|---|---|
| 2-1 | 0.075 | 0.025 |
| 2-2 | 0.0375 | 0.0125 |
| 2-3 | 0 | 0 |
| 2-4 | 0.1125 | 0.0375 |
| 2-5 | 0.15 | 0.0125 |
| 2-6 | 0.15 | 0 |

(3) Preparation of Comparison Example Phosphor No. 3 by Solid Phase Method

ZnO and SiO₂ were mixed with a mol ratio of 2:1 as the base material. Next, specific quantities of Mn₂O₃ and MgO₂ were added, mixed in a ball mill, baked at 1250° C. for 3 hours in a weakly reducing atmosphere (N₂) thereby obtaining the phosphor No. 3.

2. Evaluation of Phosphors

(1) Measurement of Concentration Distributions of Activator and Co-Activator Within the Phosphor

The concentration distributions of the activator and the co-activator within the phosphor were measured for the phosphors No. 1 to No. 3 obtained using the methods described above.

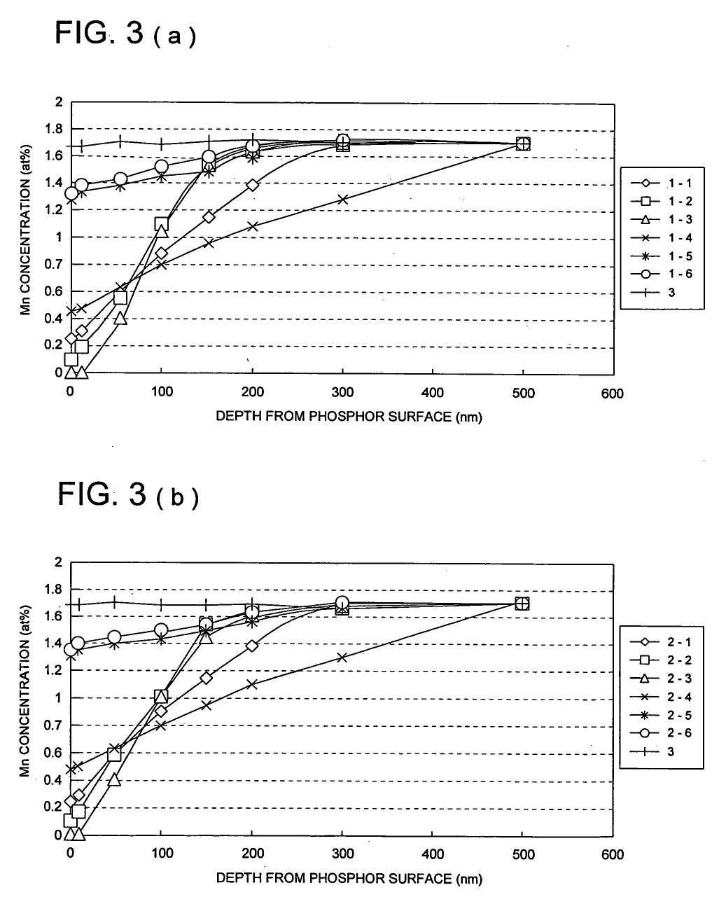

The measurement of concentration distribution of activator and co-activator within the phosphor was carried out using an X-ray electron spectrophotometer (XPS, manufactured by Nitto Denko) while etching the phosphors No. 1 to No. 3 using Ar ion etching by analyzing the activator (Mn) and co-activator (Mg) present in the phosphor from the outermost surface of the phosphor up to a depth shown in FIG. 3, and the concentration distributions of the activator and of the co-activator were expressed as molar ratios (At %).

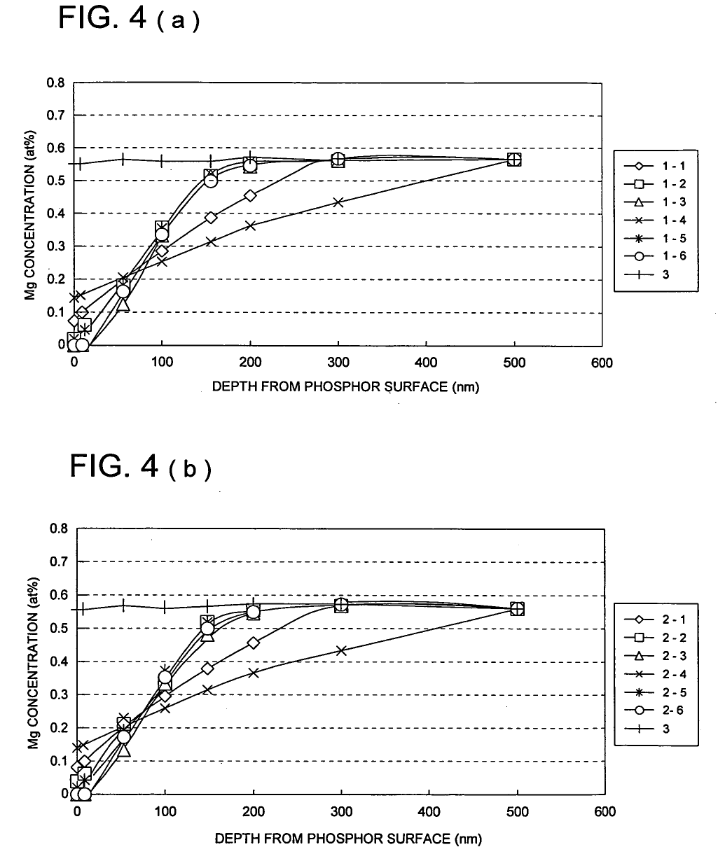

Further, the results of measurement of the concentration distributions of the activator and the co-activator for the phosphors No. 1-1 to No. 1-6, and for the phosphor No. 3 are shown in FIG. 3(a) and FIG. 4(a), and the results of measurement of the concentration distributions of the activator and the co-activator for the phosphors No. 2-1 to No. 2-6, and for the phosphor No. 3 are shown in FIG. 3(b) and FIG. 4(b).

(2) Paste Baking Degradation Test

Pastes were prepared from the phosphor No. 1 to No. 3 obtained using the methods described above, and the extent of reduction in the luminance before and after baking (luminance retention rate) was measured.

Firstly, pastes comprising ethyl cellulose resin and solvent were prepared using conventionally known methods so that the ratio of the phosphor No. 1 to No. 3 became 35%. At this time, the viscosity of the paste was adjusted using the solvent so that the paste can be coated on a glass plate for plasma display panels.

Thick film printing was carried out on the glass plate using this plate in the screen printing method, and a film of the phosphor was obtained in the shape of a layer by baking in air at 500° C. for 30 minutes. Further, this phosphor film was prepared assuming a plasma display panel.

Taking the luminance as 100% when measured in the powder state for this phosphor film before baking the paste, the luminance was measured of the phosphor after baking, and the rate of luminance retention (%) before and after baking the paste is given in Table 3 below. Further, luminance retention rates of the phosphor layer formed using the phosphor No. 1 and the phosphor No. 2 are expressed as a relative value taking as 100% the luminance of the phosphor layer formed using the phosphor No. 3 before baking.

In addition, the measurement of the luminance was made using a 146 nm excimer lamp (manufactured by Ushio Electric) as the light source, the glass plates on which the layers of phosphors had been formed were placed inside a vacuum chamber, light beam was impinged on the phosphor from a specific distance at a vacuum level of 0.1 torr, the intensity of the light emitted by stimulation was measured using a luminance meter, and the results are shown in Table 3 below.

(3) Vacuum Ultraviolet Ray Degradation Test

The luminous intensities were measured for the phosphor film obtained by baking the paste according to the method described above before and after irradiation with 146 nm vacuum ultraviolet rays (generated using an excimer lamp manufactured by Ushio Electric) for 200 hours, and the extent to which the luminance decreases upon irradiation with vacuum ultraviolet rays over long durations (luminance retention rate) is shown in Table 3 below. Further, the luminance retention rate was obtained using the following Equation (1) from the vacuum ultraviolet ray degradation test. Luminance retention rate (%)=(Luminance after 200 hours)/(luminance after baking)×100 . . . (1)

(4) Ion Sputtering Degradation Test

After forming a phosphor film by pouring paste in a cell having a cylindrical shaped depression with a diameter of 25 mm and depth of 5 mm and baking the paste, it was placed inside an Ar ion sputtering equipment and subjected to irradiation with Ar ions with an energy of 10 w for 3 minutes, and the luminance retention rate after irradiation relative to before irradiation was measured and the result is shown in Table 3 below.

(5) Persistence Evaluation

The persistence time was measured using a phosphor life measurement equipment (manufactured by Photon Technology International) of the phosphor in the powder state before baking the paste obtained by the method described above. The persistence time is the time interval after shutting off the excitation light when the luminance becomes 1/10^{th} of the luminance immediately prior to shutting of the excitation light, and the measurement result has been shown in Table 3 below in terms of a relative time duration value taking the time for the phosphor No. 3 as 100.

TABLE 3

| | | | Vacuum | | | |
|---|---|---|---|---|---|---|
| | | | ultraviolet | | | |
| | | Paste | ray | Ion | | |
| | | baking | irradiation | sputtering | | |
| | | luminance | luminance | luminance | Relative | |
| Phosphor | Initial | retention | retention | retention | persistence | |
| No. | luminance | rate (%) | rate (%) | rate (%) | time (%) | Remarks |
| 1-1 | 107 | 97 | 86 | 87 | 70 | This |
| | | | | | | invention |
| 1-2 | 107 | 98 | 88 | 91 | 75 | This |
| | | | | | | invention |
| 1-3 | 104 | 99 | 90 | 97 | 65 | This |
| | | | | | | invention |
| 1-4 | 106 | 95 | 82 | 84 | 80 | This |
| | | | | | | invention |
| 1-5 | 107 | 96 | 84 | 85 | 76 | This |
| | | | | | | invention |
| 1-6 | 104 | 96 | 84 | 91 | 68 | This |
| | | | | | | invention |
| 2-1 | 103 | 92 | 76 | 77 | 80 | This |
| | | | | | | invention |
| 2-2 | 103 | 93 | 78 | 81 | 85 | This |
| | | | | | | invention |
| 2-3 | 101 | 94 | 80 | 87 | 75 | This |
| | | | | | | invention |
| 2-4 | 103 | 90 | 72 | 74 | 90 | This |
| | | | | | | invention |
| 2-5 | 102 | 91 | 74 | 75 | 86 | This |
| | | | | | | invention |
| 2-6 | 101 | 92 | 76 | 81 | 78 | This |
| | | | | | | invention |
| 3 | 100 | 80 | 60 | 58 | 100 | Comparison |
| | | | | | | sample |

As a result, as is evident from FIG. 3 and FIG. 4 or from Table 3, in the case of the phosphor according to the present invention in which the concentration of the co-activator increases from the outermost surface of the phosphor towards its interior, the degradation due to paste baking, degradation due to vacuum ultraviolet rays, and the degradation due to ion sputtering have been improved to a large degree, and even the persistence time has been shortened.

Further, similar effect is also observed by making the concentrations of the co-activator increase from the outermost surface of the phosphor towards its interior, and in particular, it can be seen that very significant effect is observed in the degradation due to ion sputtering and also the persistence time has become shorter.

In addition, in the case of the phosphor No. 1-3, phosphor No. 1-6, phosphor No. 2-3, and the phosphor No. 2-6, in which cases only the base material is present from the outermost surface up to a depth of 10 nm and the concentration of the co-activator increases towards the interior of the phosphor, it can be seen that there is a further improvement in the degradation due to ion sputtering.

### Example 2

In Example 2, the phosphors No. 4 and No. 5 according to the present invention using (YₓGd₁₋ₓ)BO₃:Eu:In as the red phosphor (where, (YₓGd₁₋ₓ)BO₃ is the phosphor base material, Eu is the activator, and In is the co-activator) and the phosphor No. 6 as the comparison example were prepared, and for the obtained phosphors No. 4 to No. 6, in a manner similar to Example 1, not only the concentration distributions of the activator and co-activator in the obtained phosphors were measured, but also the paste baking degradation test, the vacuum ultraviolet ray degradation test, and the ion sputtering degradation test were carried out, and the relative luminous intensities before and after degradation in each process were evaluated. Further, the persistence times of the phosphors were measured thereby carrying out the persistence evaluation. To begin with, the synthesis of the phosphors No. 4 to No. 6 is explained below.

1. Preparation of Phosphors

(1) Preparation of Phosphor No. 4 by Liquid Phase Method

Water of 1000 ml was taken as liquid D. Y(NO₃)₃.6H₂O, Gd(NO₃)₃, Eu(NO₃)₃.6H₂O, and In(NO₃)₃.3H₂O were dissolved in 500 ml of water so that the ion concentration of Y becomes 0.4659 mol/l, the ion concentration of Gd becomes 0.2716 mol/l, the ion concentration of Y becomes 0.4659 mol/l, the concentration of the activator (Eu) becomes 0.0388 mol/l, and the concentration of the co-activator (In) becomes 0.012 mol/l, and this was taken as liquid E. H₃BO₃ was dissolved in 500 ml of water so that the ion concentration of B becomes 0.7763 mol/l, and this was taken as liquid F.

Thereafter, the solution D was put in the reaction container 2 of the double jet type reaction apparatus 1 which is the equipment for manufacturing the phosphor as shown in FIG. 1 and used in Example 1, maintained at 40° C. and was stirred using the stirring blades 3. In this condition, the solutions E and F maintained at 40° C. were added at a constant speed of 100 ml/min using pumps via the nozzles 6 and 7 at the bottom part of the reaction container 1 having the solution D. After adding the solutions, the mixture was aged for 10 minutes, thereby obtaining the precursor of the phosphor.

Thereafter, the precursor was cleaned using an ultra-purification equipment (ultra-purification film NTU-3150 manufactured by Nitto Denko) until the electrical conductivity became 30 mS/cm. The precursor after cleaning was added to 1000 ml of water and this was again put in the reaction container 2 of FIG. 1, and the dispersed liquid was obtained by stirring this using the stirring blades 3 while maintaining at 40° C. until it was dispersed uniformly.

In this state, the solution E′ maintained at 60° C. and having Y(NO₃)₃.6H₂O, Gd(NO₃)₃, and In(NO₃)₃.3H₂O dissolved in it so that the ion concentration of Y, the ion concentration of Gd, the ion concentration of Eu, and the ion concentration of In in 500 ml of water become the concentrations listed in the following Table 4, and the solution F′ maintained at 40° C. and having H₃BO₃ dissolved in it so that the ion concentration of B ions in 500 ml of water becomes the density listed in the following Table 4 are added using pumps at a constant rate of 50 ml/min from the nozzles 6 and 7 present at the bottom part of the reaction container 1 in which the dispersed liquid B has been poured. The mixture was aged for 10 minutes after addition, and thereafter the dry precursor was obtained by filtering and drying. This was baked at 1400° C. for 2 hours in an oxidizing atmosphere (air) thereby obtaining the phosphors No. 4-1 to 4-6.

TABLE 4

| | Y ion | Gd ion | Eu ion | In ion | B ion |
|---|---|---|---|---|---|
| Phosphor | concentration | concentration | concentration | concentration | concentration |
| No. | (mol/l) | (mol/l) | (mol/l) | (mol/l) | (mol/l) |
| 4-1 | 0.45 | 0.25 | 0.018 | 0.0055 | 0.73 |
| 4-2 | 0.45 | 0.25 | 0.009 | 0.0022 | 0.73 |
| 4-3 | 0.45 | 0.25 | 0 | 0 | 0.73 |
| 4-4 | 0.45 | 0.25 | 0.027 | 0.008 | 0.73 |
| 4-5 | 0.45 | 0.25 | 0.036 | 0.0022 | 0.73 |
| 4-6 | 0.45 | 0.25 | 0.036 | 0 | 0.73 |

(2) Preparation of Phosphor No. 5 by Solid Phase Method

Y₂O₃, Gd₂O₃, Eu₂O₃, H₃BO₃ and In₂O₃ were mixed as the base material with a mol ratio of 0.6:0.3:0.1:1.0:0.02. Next, an appropriate quantity of flux was added to this mixture and mixed in a ball mill, and was baked at 1400° C. in an oxidizing atmosphere (air) for 3 hours.

After further mixing the base materials Y₂O₃, Gd₂O₃, and H₃BO₃, with the synthesized phosphor, Eu₂O₃ and In₂O₃ were added so that their weight ratios become as listed in Table 5 below, mixed in a ball mill, baked again at 1300° C. for 1.5 hours in air thereby obtaining the phosphors No. 5-1 to 5-6.

TABLE 5

| Phosphor No. | Eu/Y ratio | In/Y ratio |
|---|---|---|
| 5-1 | 0.042 | 0.0013 |
| 5-2 | 0.021 | 0.0065 |
| 5-3 | 0 | 0 |
| 5-4 | 0.033 | 0.0195 |
| 5-5 | 0.081 | 0.0065 |
| 5-6 | 0.081 | 0 |

(3) Preparation of Comparison Example Phosphor No. 6 by Solid Phase Method

Y₂O₃, Gd₂O₃, Eu₂O₃, H₃BO₃ and In₂O₃ were mixed as the base material with a mol ratio of 0.6:0.3:0.1:1.0:0.02. Next, an appropriate quantity of flux was added to this mixture and mixed in a ball mill, and was baked at 1400° C. in an oxidizing atmosphere (air) for 2 hours thereby obtaining the phosphor No. 6.

2. Evaluation of Phosphors

(1) Measurement of Concentration Distributions of Activator and Co-Activator Within the Phosphor

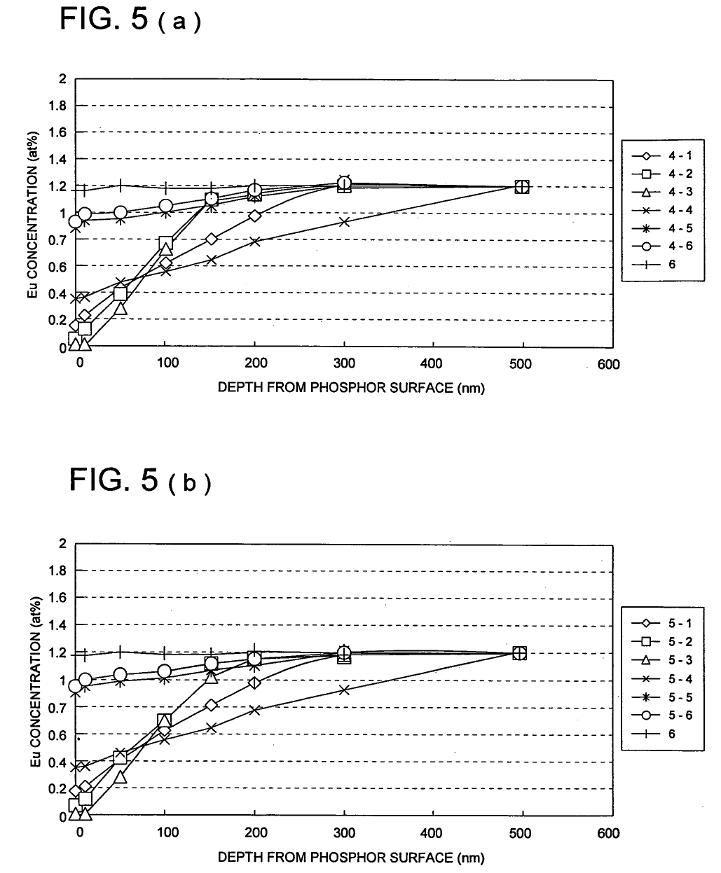

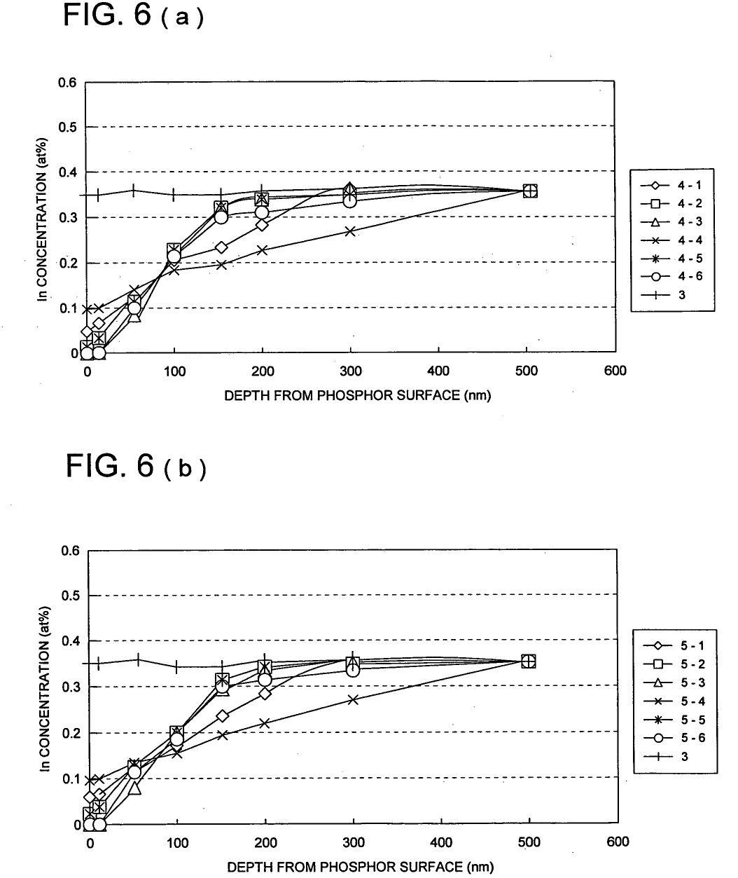

The concentration distributions of the activator (Eu) and the co-activator (In) within the phosphor were measured, in a manner similar to that in Example 1, for the phosphors No. 4 to No. 6 obtained using the methods described above. Further, the results of measurement of the concentration distributions of the activator and co-activator for the phosphors No. 4-1 to No. 4-6, and for the phosphor No. 6 are shown in FIG. 5(a) and FIG. 6(a), and the results of measurement of the density distributions of the activator and co-activator for the phosphors No. 5-1 to No. 5-6, and for the phosphor No. 6 are shown in FIG. 5(b) and FIG. 6(b).

(2) Paste Baking Degradation Test

Pastes were prepared, in a manner similar to Example 1, from the phosphors No. 4 to No. 6 obtained using the methods described above, and the extent of reduction in the luminance before and after baking was measured in a manner similar to that in Example 1 (luminance retention rate), and the results are shown in Table 6 below.

(3) Vacuum Ultraviolet Ray Degradation Test

Paste preparation and paste baking were carried out, in a manner similar to that in Example 1, from the phosphors No. 4 to No. 6 obtained using the methods described earlier, and for the phosphor layer so obtained, the extent to which the luminance decreases upon irradiation with vacuum ultraviolet rays over long durations (luminance retention rate), measured in a manner similar to that in Example 1, is shown in Table 6 below.

(4) Ion Sputtering Degradation Test

Paste preparation and paste baking were carried out, in a manner similar to that in Example 1, from the phosphors No. 4 to No. 6 obtained using the methods described earlier, and for the phosphor layer so obtained, irradiation with Ar ions was carried out, and the luminance retention rate after irradiation relative to before irradiation was measured and the result is shown in Table 6 below.

(5) Persistence Evaluation

Paste preparation was carried out, in a manner similar to that in Example 1, from the phosphors No. 4 to No. 6 obtained using the methods described earlier, and the persistence time of the phosphor in the powder state before baking the paste was measured, and the measurement result has been shown in Table 6 below.

TABLE 6

| | | | Vacuum | | | |
|---|---|---|---|---|---|---|
| | | | ultraviolet | | | |
| | | Paste | ray | Ion | | |
| | | baking | irradiation | sputtering | | |
| | | luminance | luminance | luminance | Relative | |
| Phosphor | Initial | retention | retention | retention | persistence | |
| No. | luminance | rate (%) | rate (%) | rate (%) | time (%) | Remarks |
| 4-1 | 107 | 97 | 86 | 87 | 70 | This |
| | | | | | | invention |
| 4-2 | 107 | 98 | 88 | 92 | 75 | This |
| | | | | | | invention |
| 4-3 | 104 | 99 | 90 | 97 | 65 | This |
| | | | | | | invention |
| 4-4 | 106 | 95 | 82 | 83 | 80 | This |
| | | | | | | invention |
| 4-5 | 107 | 96 | 84 | 84 | 76 | This |
| | | | | | | invention |
| 4-6 | 104 | 96 | 84 | 90 | 68 | This |
| | | | | | | invention |
| 5-1 | 103 | 92 | 76 | 78 | 80 | This |
| | | | | | | invention |
| 5-2 | 103 | 93 | 78 | 83 | 85 | This |
| | | | | | | invention |
| 5-3 | 101 | 94 | 80 | 88 | 75 | This |
| | | | | | | invention |
| 5-4 | 103 | 90 | 72 | 73 | 90 | This |
| | | | | | | invention |
| 5-5 | 102 | 91 | 74 | 74 | 86 | This |
| | | | | | | invention |
| 5-6 | 101 | 92 | 76 | 79 | 78 | This |
| | | | | | | invention |
| 6 | 100 | 80 | 60 | 58 | 100 | Comparison |
| | | | | | | sample |

As is evident from FIG. 5 and FIG. 6 or from Table 6, in the case of the phosphor according to the present invention in which the concentration of the co-activator increases from the outermost surface of the phosphor towards its interior, the degradation due to paste baking, degradation due to vacuum ultraviolet rays, and the degradation due to ion sputtering have been improved to a large degree, and even the persistence time has been shortened.

In addition, similar effect is also observed by making the concentrations of the co-activator increase from the outermost surface of the phosphor towards its interior, and in particular, it can be seen that very significant effect is observed in the degradation due to ion sputtering and also the persistence time has become shorter.

In addition, in the case of the phosphor No. 4-3, phosphor No. 4-6, phosphor No. 5-3, and the phosphor No. 5-6, in which cases only the base material is present from the outermost surface up to a depth of 10 nm and the concentration of the co-activator increases towards the interior of the phosphor, it can be seen that there is a further improvement in the degradation due to ion sputtering.

### Example 3

In Example 3, the phosphors No. 7 and No. 8 according to the present invention using BaMgAl₁₀O₁₇:Eu:Sc as the blue phosphor (where, BaMgAl₁₀O₁₇ is the phosphor base material, Eu is the activator, and Sc is the co-activator) and the phosphor No. 9 as the comparison example were prepared, and for the obtained phosphors, not only the concentration distributions of the activator and co-activator in the obtained phosphors were measured, but also the paste baking degradation test, the vacuum ultraviolet ray degradation test, and the ion sputtering degradation test were carried out, and the relative luminous intensities before and after degradation in each process were evaluated. Further, the persistence times of the phosphors were measured thereby carrying out the persistence evaluation. To begin with, the synthesis of the phosphors No. 7 to No. 9 is explained below.

1. Preparation of Phosphors

(1) Preparation of Phosphor No. 8 by Liquid Phase Method

Water of 1000 ml was taken as liquid G. BaCl₂.2H₂O, MgCl₂.6H₂O, EuCl₃.6H₂O, and ScCl₃.6H₂O were dissolved in 500 ml of water so that the ion concentration of Ba becomes 0.0900 mol/l, the ion concentration of Mg becomes 0.1000 mol/l, the concentration of the activator (Eu) becomes 0.01 mol/l, and the concentration of the co-activator (Sc) becomes 0.003 mol/l, and this was taken as liquid H. AlCl₃.6H₂O was dissolved in 500 ml of water so that the ion concentration of Al becomes 1000 mol/l, and this was taken as liquid I.

Thereafter, the solution G was put in the reaction container 2 of the double jet type reaction apparatus 1 which is the equipment for manufacturing the phosphor as shown in FIG. 1 and used in Example 1 and in Example 2, maintained at 40° C. and was stirred using the stirring blades 3. In this condition, the solutions H and I maintained also at 40° C. were added at a constant speed of 100 ml/min using pumps via the nozzles 6 and 7 at the bottom part of the reaction container 1 having the solution G. After adding the solutions, the mixture was aged for 10 minutes, thereby obtaining the precursor of the phosphor.

Thereafter, the precursor was cleaned using an ultra-purification equipment (ultra-purification film NTU-3150 manufactured by Nitto Denko) until the electrical conductivity became 30 mS/cm. The precursor after cleaning was added to 1000 ml of water and this was again put in the reaction container 2 of FIG. 1, and the dispersed liquid was obtained by stirring this using the stirring blades 3 while maintaining at 40° C. until it was dispersed uniformly.

In this state, the solution H′ also maintained at 40° C. and having BaCl₂.2H₂O, MgCl₂.6H₂O, EuCl₃.6H₂O, and ScCl₃.6H₂O dissolved in it so that the ion concentrations of each of the ions Ba, Mg, Eu, and Sc in 500 ml of water become the densities listed in the following Table 7, and the solution I′ having AlCl₃ dissolved in it so that the ion concentration of Al ions in 500 ml of water becomes the concentration listed in the following Table 7 are added using pumps at a constant rate of 50 ml/min from the nozzles 6 and 7 present at the bottom part of the reaction container 1 in which the dispersed liquid has been poured. The mixture was aged for 10 minutes after addition, and thereafter the dry precursor was obtained by filtering and drying. This was baked at 1600° C. for 2 hours in a reducing atmosphere (in H₂ gas) thereby obtaining the phosphors No. 7-1 to 7-6.

TABLE 7

| | Ba ion | Mg ion | Al ion | Eu ion | Sc ion |
|---|---|---|---|---|---|
| Phosphor | concentration | concentration | concentration | concentration | concentration |
| No. | (mol/l) | (mol/l) | (mol/l) | (mol/l) | (mol/l) |
| 7-1 | 0.085 | 0.09 | 0.9 | 0.045 | 0.0014 |
| 7-2 | 0.085 | 0.09 | 0.9 | 0.022 | 0.0007 |
| 7-3 | 0.085 | 0.09 | 0.9 | 0 | 0 |
| 7-4 | 0.085 | 0.09 | 0.9 | 0.0675 | 0.0021 |
| 7-5 | 0.085 | 0.09 | 0.9 | 0.09 | 0.0007 |
| 7-6 | 0.085 | 0.09 | 0.9 | 0.09 | 0 |

(2) Preparation of Phosphor No. 8 by Solid Phase Method

BaCO₃, MgCO₃, and α-Al₂O₃ were mixed as the base material with a mol ratio of 1:1:5. Next, specific quantities of Eu₂O₃ and Sc₂O₃ were added to this mixture. At this time, Eu₂O₃ and Sc₂O₃ were added so that their ratios are 0.1 and 0.03 taking BaCO₃ as 1. Next, they were mixed in a ball mill along with an appropriate quantity of flux (AlF₂ and BaCl₂), and were baked at 1600° C. in a reducing atmosphere (in H₂ gas) for 3 hours.

After further mixing the base materials BaCO₃, MgCO₃, and α-Al₂O₃ with the synthesized phosphor, Eu₂O₃ and Sc₂O₃were added so that their weight ratios become as listed in Table 8 below, mixed in a ball mill, baked at 1600° C. for 1.5 hours in air thereby obtaining the phosphors No. 8-1 to No. 8-6.

TABLE 8

| Phosphor No. | Eu/Ba ratio | Sc/Ba ratio |
|---|---|---|
| 8-1 | 0.055 | 0.017 |
| 8-2 | 0.0225 | 0.0085 |
| 8-3 | 0 | 0 |
| 8-4 | 0.077 | 0.0255 |
| 8-5 | 0.105 | 0.0085 |
| 8-6 | 0.105 | 0 |

(3) Preparation of Comparison Example Phosphor No. 9 by Solid Phase Method

BaCO₃, MgCO₃, and α-Al₂O₃were mixed as the base material with a mol ratio of 1:1:5. Next, specific quantities of Eu₂O₃ and Sc₂O₃were added to this mixture. At this time, Eu₂O₃ and SC₂O₃were added so that their ratios are 0.1 and 0.03 taking BaCO₃ as 1. Next, they were mixed in a ball mill along with an appropriate quantity of flux (AlF₂ and BaCl₂), and were baked at 1600° C. in a reducing atmosphere (in H₂ gas) for 2 hours thereby obtaining the phosphor No. 9.

2. Evaluation of Phosphors

(1) Measurement of Concentration Distributions of Activator and Co-Activator Within the Phosphor

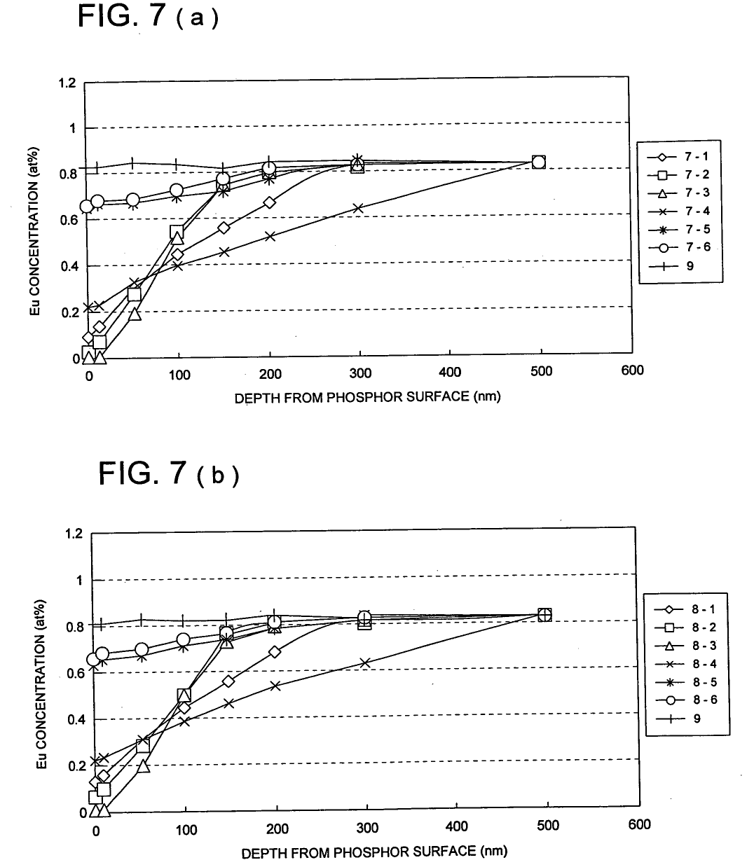

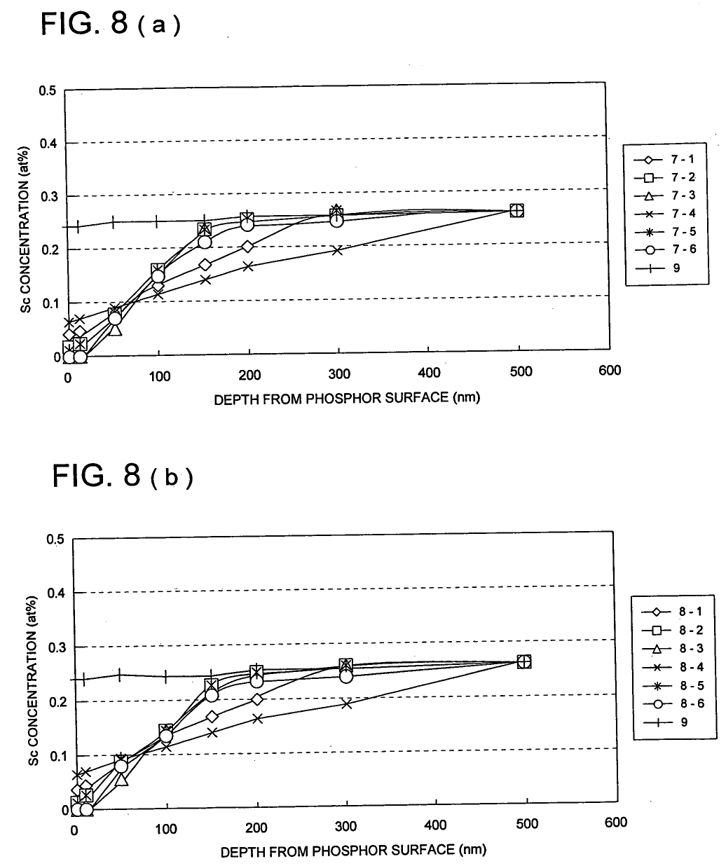

The density distributions of the activator (Eu) and the co-activator (Sc) within the phosphor were measured, in a manner similar to that in Example 1 and in Example 2, for the phosphors No. 7 to No. 9 obtained using the methods described above. Further, the results of measurement of the concentration distributions of the activator and co-activator for the phosphors No. 7-1 to No. 7-6, and for the phosphor No. 9 are shown in FIG. 7(a) and FIG. 8(a), and the results of measurement of the density distributions of the activator and co-activator for the phosphors No. 8-1 to No. 8-6, and for the phosphor No. 9 are shown in FIG. 7(b) and FIG. 8(b).

(2) Paste Baking Degradation Test

Pastes were prepared, in a manner similar to Example 1 and Example 2, from the phosphors No. 7 to No. 9 obtained using the methods described above, and the extent of reduction in the luminance before and after baking was measured in a manner similar to that in Example 1 and in Example 2 (luminance retention rate), and the results are shown in Table 9 below.

(3) Vacuum Ultraviolet Ray Degradation Test

Paste preparation and paste baking were carried out, in a manner similar to that in Example 1 and in Example 2, from the phosphors No. 7 to No. 9 obtained using the methods described earlier, and for the phosphor layer so obtained, the extent to which the luminance decreases upon irradiation with vacuum ultraviolet rays over long durations (luminance retention rate), measured in a manner similar to that in Examples 1 and 2, is shown in Table 9 below.

(4) Ion Sputtering Degradation Test

Paste preparation and paste baking were carried out, in a manner similar to that in Example 1 and in Example 2, from the phosphors No. 7 to No. 9 obtained using the methods described earlier, and for the phosphor layer so obtained, irradiation with Ar ions was carried out, and the luminance retention rate after irradiation relative to before irradiation was measured and the result is shown in Table 9 below.

(5) Persistence Evaluation

Paste preparation was carried out, in a manner similar to that in Example 1, from the phosphors No. 7 to No. 9 obtained using the methods described earlier, and the persistence time of the phosphor in the powder state before baking the paste was measured, and the measurement result has been shown in Table 9 below.

TABLE 9

| | | | Vacuum | | | |
|---|---|---|---|---|---|---|
| | | | ultraviolet | | | |
| | | Paste | ray | Ion | | |
| | | baking | irradiation | sputtering | | |
| | | luminance | luminance | luminance | Relative | |
| Phosphor | Initial | retention | retention | retention | persistence | |
| No. | luminance | rate (%) | rate (%) | rate (%) | time (%) | Remarks |
| 7-1 | 108 | 97 | 86 | 87 | 70 | This |
| | | | | | | invention |
| 7-2 | 108 | 98 | 88 | 92 | 75 | This |
| | | | | | | invention |
| 7-3 | 105 | 99 | 90 | 97 | 65 | This |
| | | | | | | invention |
| 7-4 | 106 | 95 | 82 | 83 | 80 | This |
| | | | | | | invention |
| 7-5 | 108 | 96 | 84 | 84 | 76 | This |
| | | | | | | invention |
| 7-6 | 105 | 96 | 84 | 90 | 68 | This |
| | | | | | | invention |
| 8-1 | 104 | 92 | 76 | 78 | 80 | This |
| | | | | | | invention |
| 8-2 | 104 | 93 | 78 | 83 | 85 | This |
| | | | | | | invention |
| 8-3 | 102 | 94 | 80 | 88 | 75 | This |
| | | | | | | invention |
| 8-4 | 103 | 90 | 72 | 73 | 90 | This |
| | | | | | | invention |
| 8-5 | 102 | 91 | 74 | 74 | 86 | This |
| | | | | | | invention |
| 8-6 | 101 | 92 | 76 | 79 | 78 | This |
| | | | | | | invention |
| 9 | 100 | 80 | 55 | 58 | 100 | Comparison |
| | | | | | | sample |

As is evident from FIG. 7 and FIG. 8 or from Table 9, in the case of the phosphor according to the present invention in which the concentration of the co-activator increases from the outermost surface of the phosphor towards its interior, the degradation due to paste baking, degradation due to vacuum ultraviolet rays, and the degradation due to ion sputtering have been improved to a large degree, and even the persistence time has been shortened.

In addition, similar effect is also observed by making the concentrations of the co-activator increase from the outermost surface of the phosphor towards its interior, and in particular, it can be seen that very significant effect is observed in the degradation due to ion sputtering and also the persistence time has become shorter.

In addition, in the case of the phosphor No. 7-3, phosphor No. 7-6, phosphor No. 8-3, and the phosphor No. 8-6, in which cases only the base material is present from the outermost surface up to a depth of 10 nm and the concentration of the co-activator increases towards the interior of the phosphor, it can be seen that there is a further improvement in the degradation due to ion sputtering.

What is claimed is:

1. A phosphor comprising phosphor particles containing a phosphor base material dispersed with an activator and a co-activator, wherein
a concentration of the co-activator is lower at a surface than in an interior of each particle.

2. The phosphor of claim 1, wherein
the concentration of the co-activator gradually increases from an outermost surface to the interior of each particle.

3. The phosphor of claim 1, wherein
an average concentration of the co-activator in a depth range of 0 to 100 nm from an outermost surface is 20% or more lower than the concentration of the co-activator anywhere in the interior of each particle deeper than 100 nm from the outermost surface.

4. A phosphor comprising phosphor particles containing a phosphor base material dispersed with an activator and a co-activator, wherein
each of concentrations of the activator and the co-activator is lower at a surface than in an interior of each particle.

5. The phosphor of claim 4, wherein
each of the concentrations gradually increases from an outermost surface to the interior of each particle.

6. The phosphor of claim 4, wherein
an average concentration of the activator in a depth range of 0 to 100 nm from an outermost surface is 20% or more lower than the concentration of the activator anywhere in the interior of each particle deeper than 100 nm from the outermost surface; and
an average concentration of the co-activator in the depth range of 0 to 100 nm from the outermost surface is 20% or more lower than the concentration of the co-activator anywhere in the interior of each particle deeper than 100 nm from the outer most surface.

7. The phosphor of claim 1, wherein
a portion within 10 nm from an outermost surface of each particle is consist of the phosphor base material.

8. The phosphor of claim 4, wherein
a portion within 10 nm from an outermost surface of each particle is consist of the phosphor base material.

9. The phosphor of claim 1, wherein
the phosphor base material is BaMgAl₁₀O₁₇;
the activator contains Eu; and
the co-activator contains Be, Mg, an alkaline earth metal, a transition metal or a rare earth metal.

10. The phosphor of claim 4, wherein
the phosphor base material is BaMgAl₁₀O₁₇;
the activator contains Eu; and
the co-activator contains Be, Mg, an alkaline earth metal, a transition metal or a rare earth metal.

11. The phosphor of claim 1, wherein
the phosphor base material is ZnₓSiO₄;
the activator is Mn_{y}; and
the co-activator is Ml_{z},
wherein
Ml is Be, Mg, an alkaline earth metal, a transitional metal or a rare earth metal; and
1.4≦x<2.0, 0<y≦0.3 and 0<z≦0.2.

12. The phosphor of claim 4, wherein
the phosphor base material is ZnₓSiO₄;
the activator is Mn_{y}; and
the co-activator is Ml_{z},
wherein
Ml is Be, Mg, an alkaline earth metal, a transitional metal or a rare earth metal; and
1.4x≦2.0, 0<y≦0.3 and 0<z≦0.2.

13. The phosphor of claim 1, wherein
the phosphor base material is (YₓGd₁₋ₓ)BO₃;
the activator contains Eu; and
the co-activator contains Be, Mg, an alkaline earth metal, a transition metal or a rare earth metal.

14. The phosphor of claim 4, wherein the phosphor base material is (YₓGd₁₋ₓ)BO₃;
the activator contains Eu; and
the co-activator contains Be, Mg, an alkaline earth metal, a transition metal or a rare earth metal.

15. A plasma display comprising a discharge cell containing the phosphor of claim 1.

16. A plasma display comprising a discharge cell containing the phosphor of claim 4.
